(19) United States
(12) Patent Application Publication
(10) Pub. No.: US 2012/0151281 A1
(43) Pub. Date: Jun. 14, 2012

(54) APPARATUSES AND METHODS FOR IDENTIFICATION OF EXTERNAL INFLUENCES ON AT LEAST ONE PROCESSING UNIT OF AN EMBEDDED SYSTEM

(76) Inventors: Ulrich Hahn, Neustadt/A. (DE); Martin Rothfelder, Munchen (DE)

(21) Appl. No.: 13/391,164

(22) PCT Filed: Jul. 16, 2010
(86) PCT No.: PCT/EP10/60281

§ 371 Date: Feb. 17, 2012

(30) Foreign Application Priority Data
Aug. 17, 2009 (DE) 10 2009 037 721.2

(51) Int. Cl. G06F 11/08

(52) U.S. Cl. 714/48; 714/E11.03

(57) ABSTRACT

Apparatuses and methods are provided for the identification of external influences on at least one processing unit in a set of processing units in an embedded system. An arrangement configured for this purpose may include: a data generator configured to generate data which is designed to identify external influences on at least one processing unit in the set of processing units; a sensor circuit including a set of electronic elements, wherein the electronic elements are configured to store data, wherein the sensor circuit is configured to transmit the data to a data checker by sequential buffer storage of the data in the electronic elements; and the data checker, configured to check the correctness of the data.

### CROSS-REFERENCE TO RELATED APPLICATIONS

This application is a U.S. National Stage application of International Application No. PCT/EP2010/060281 filed Jul. 16, 2010, which designates the United States of America, and claims priority to DE Patent Application No. 10 2009 037 721.2 filed Aug. 17, 2009. The contents of which are hereby incorporated by reference in their entirety.

### TECHNICAL FIELD

The present disclosure relates to the identification of external influences on at least one processing unit of an embedded system. In particular, the present disclosure may relate to arrangements, methods and data units configured or designed to identify external influences on at least one processing unit of an embedded system. The present disclosure further relates to an embedded system that comprises the arrangement for the identification of external influences on at least one processing unit of the embedded system.

### BACKGROUND

When designing embedded systems, one, two or more processing units or components (for example, channels, main processors in multiprocessor configurations and so forth) are placed on a chip, the processing units or components being units or components of an embedded system. To ensure a safe and/or reliable functioning and/or operation of such embedded systems, the results from the processing units or components of an embedded system are compared with one another by corresponding safety-related control devices in order to detect or disclose errors that have possibly occurred in at least one of the processing units or components. The respective safety-related control devices can optionally be configured such as to induce a corresponding predetermined response (for example, establishment of a safe system state) when errors occur.

However, it is not only internal processing errors that may occur. In an embedded system, failures of processing units or components and/or errors in processing units or components may have negative impacts on at least one further processing unit or component in the embedded system. Furthermore, negative influences from outside (for example, radiation, an increased temperature, mechanical phenomena, influences from the power supply and so forth) may also occur in an embedded system and exert negative impacts on at least one processing unit or component of the embedded system. Such failures and/or errors in a processing unit or component and/or negative influences from outside are referred to hereafter in general as “external influences” or as “outside influences”. Such “external influences” or “outside influences” have physical effects, as a result of which negative impacts on at least one further processing unit or component occur or may occur. Such failures of processing units or components and/or errors in processing units or components have physical effects that are active at least in a specific perimeter around the failed or faulty processing units or components and impact or may impact negatively on at least one further processing unit or component located within said perimeter that has not failed or become faulty hitherto. The general negative influences from outside usually occur in a zone of an embedded system and may be active in a specific perimeter around this zone. The processing units or components of an embedded system that are located in this zone and within the specific perimeter may experience negative impacts as a result of these negative influences from outside.

Such external influences may lead to faulty performance of the affected processing units or components in the respective embedded system. In the worst scenario, the impacts of such external influences may also include failures of at least one affected processing unit. Although in an embedded system the aforementioned comparison of the results from the processing units or components of the embedded system is carried out by at least one corresponding safety-related control device, failures and/or errors in processing units or components that are triggered by such external influences are often not detected or pinpointed. Although a failure or faulty operation of at least one processing unit or component of the embedded system occurs as a result of an external influence, it can happen that an intended or defined response to errors for this situation is not set in motion, that is, that the embedded system continues to be operated without any corrective intervention and despite errors and/or failures.

Such external influences also include the “error transfer” of internal errors and/or of failures from a failed or faulty processing unit or component to a different processing unit or component in an embedded system which has not yet failed and is not yet faulty. Thus, for example, a hotspot, following a short circuit in a channel caused by the thermal bridge across the semi-conductor or other components may, for instance, have a negative impact on another channel too. Furthermore, for example, a stuck-at error on a signal that is being transmitted from one channel to the other can have a negative impact on circuit components in a different core processor (as a result of overload, for example). Furthermore, a hotspot in an output driver of a core processor may have a negative impact on a further core processor due to an off-chip short circuit.

Known procedures for the identification of such external or outside influences on a processing unit or component in an embedded system have hitherto involved a number of disadvantages. Their implementation is often costly and/or complex. Furthermore, the known procedures for the identification of such external or outside influences often suffer from a lack of or inadequate autonomy, that is, from the lack of or an inadequate strategy for increasing the system reliability. Furthermore, the existing procedures only have a lacking or completely inadequate safety-related effect in an embedded system and so forth.

Consequently, there continues to be a demand for an improved method for the identification or detection of such external or outside influences on processing units or components of embedded systems.

### SUMMARY

In one embodiment, an arrangement is provided for the identification of external influences on at least one processing unit pertaining to a set of processing units in an embedded system, wherein the arrangement comprises: a data generator, which is configured to generate data that are configured for the identification of external influences on at least one processing unit pertaining to the set of processing units; a sensor circuit, comprising a set of electronic elements, wherein the electronic elements are configured for the storage of the data, wherein the sensor circuit is configured to transmit the data to a data checker by means of a sequential intermediate storage of the data in the electronic elements; and the data checker, which is configured to check the correctness of the data.

In a further embodiment, the electronic elements are arranged on the processing units pertaining to the set of processing units. In a further embodiment, the electronic elements pertaining to the set of electronic elements are arranged sequentially. In a further embodiment, the data comprise a data pattern, which is configured for the identification of external influences on at least one processing unit pertaining to the set of processing units. In a further embodiment, the data have a time stamp indicates at what the time the data were generated by the data generator for transmission to the sensor circuit. In a further embodiment, the data comprise an error detection suffix, wherein the error detection suffix is configured such that the checking of the correctness of the data is carried out by the data checker, using the error detection suffix. In a further embodiment, the data generator is configured to generate the error detection suffix using the data pattern. In a further embodiment, the data generator is configured to generate the error detection suffix using the data pattern as claimed in at least one of the preceding claims, wherein the arrangement comprises a power supply for the sensor circuit to supply the sensor circuit with power.

In a further embodiment, the sensitivity of the sensor circuit is regulated with respect to external influences by a selection of a level of a voltage that is provided by the power supply to the sensor circuit. In a further embodiment, the arrangement comprises a transmitter that is configured to receive the data from the data generator and transmit said data in cycles to the sensor circuit. In a further embodiment, the data generator is configured to generate the data in cycles. In a further embodiment, the arrangement comprises a receiver that is configured to receive the data from the sensor circuit and supply said data to the data checker.

In a further embodiment, the arrangement comprises an observation circuit that is configured to check for accuracy signals that are transmitted by a first processing unit pertaining to the set of processing units to a second processing unit pertaining to the set of processing units. In a further embodiment, the observation circuit is configured to check input signals, intermediate signals and/or output signals pertaining to the first processing unit, wherein input signals, intermediate signals and/or output signals are such signals from which the signals transmitted by the first processing unit to the second processing unit originate. In a further embodiment, the data checker is configured to compare the data generated by the data generator with the data that the data checker has received from the sensor circuit, wherein the data generated by the data generator correspond to the data that the data checker has received from the sensor circuit. In a further embodiment, the set of processing units comprises at least one of the following as a processing unit: a channel and/or a main processor.

In another embodiment, an embedded system is provided, which comprises an arrangement for the identification of external influences on at least one processing unit pertaining to a set of processing units in the embedded system, wherein the arrangement comprises: a data generator, which is configured to generate data that are configured for the identification of external influences on at least one processing unit pertaining to the set of processing units; a sensor circuit, comprising a set of electronic elements, wherein the electronic elements are configured for the storage of the data, wherein the sensor circuit is configured to transmit the data to a data checker by means of a sequential intermediate storage of the data in the electronic elements; and the data checker, which is configured to check the correctness of the data.

In another embodiment, a method is provided for the identification of external influences on at least one processing unit pertaining to a set of processing units in an embedded system. The method may comprise: generation of data that are configured for the identification of external influences on at least one processing unit pertaining to the set of processing units; transmission of the data to a data checker by a sensor circuit that comprises a set of electronic elements that are configured for the storage of the data, wherein the sensor circuit transmits the data to the data checker by a sequential intermediate storage of the data in the electronic elements; and checking of the correctness of the data by the data checker.

In another embodiment, a data unit is provided, which data unit: is configured for the identification of external influences on at least one processing unit pertaining to a set of processing units in an embedded system; is configured for transmission by a sensor circuit to a data checker for the identification of external influences, wherein the sensor circuit comprises a set of electronic elements that are configured for the storage of data, and wherein the sensor circuit transmits the data unit to the data checker by a sequential storage of the data unit in the electronic elements; and is configured to check the correctness thereof by means of the data checker.

In a further embodiment, the data unit comprises a data pattern that is configured for the identification of external influences on at least one processing unit pertaining to the set of processing units. In a further embodiment, the data unit comprises an error detection suffix; and the error detection suffix is configured such that the checking of the correctness of the data unit is carried out by the data checker using the error detection suffix. In a further embodiment, the error detection suffix is generated using the data pattern. In a further embodiment, the data unit comprises a time stamp that indicates at what time the data unit was generated. In a further embodiment, the error detection suffix is generated using the data pattern.

### BRIEF DESCRIPTION OF THE DRAWINGS

Example embodiments will be explained in more detail below with reference to figures, in which:

FIG. 1 shows an example arrangement for the identification of external influences on at least one processing unit or component pertaining to a set of processing units or components in an embedded system according to an exemplary embodiment of the present disclosure;

FIG. 2 shows an example arrangement for the identification of external influences on at least one processing unit or component pertaining to a set of processing units or components in an embedded system according to an exemplary embodiment of the present disclosure;

FIG. 3 shows an example arrangement for the identification of external influences on at least one processing unit or component pertaining to a set of processing units or components in an embedded system according to an exemplary embodiment of the present disclosure;

FIG. 4 shows an example arrangement for the identification of external influences on at least one processing unit or component pertaining to a set of processing units or components in an embedded system according to an exemplary embodiment of the present disclosure;

FIG. 5a shows an example data unit according to an exemplary embodiment configured for the identification of external influences on at least one processing unit or component pertaining to a set of processing units or components in an embedded system;

FIG. 5b shows an example data unit that is configured according to an exemplary embodiment for the identification of external influences on at least one processing unit or component pertaining to a set of processing units or components in an embedded system; and

FIG. 5c shows an example data unit that, according to an exemplary embodiment configured for the identification of external influences on at least one processing unit or component pertaining to a set of processing units or components in an embedded system.

### DETAILED DESCRIPTION

Certain embodiments of the present disclosure provide improved identification, diagnosis or detection of external or outside influences on at least one processing unit or component of an embedded system.

Some embodiments provide an arrangement for the identification of external influences on at least one processing unit pertaining to a set of processing units in an embedded system, wherein the arrangement may include:
a data generator that is configured to generate data which are configured for the identification of external influences on at least one processing unit pertaining to the set of processing units;
a sensor circuit comprising a set of electronic elements, wherein the electronic elements are configured for the storage of data, and the sensor circuit is configured to transmit the data to a data checker by means of a sequential intermediate storage of the data in the electronic elements;
the data checker that is configured to check the correctness of the data.

In this way certain embodiments may allow a reliable and safe identification of external influences in an embedded system, which can be implemented in a safe and cost-saving manner.

According to an exemplary embodiment, the electronic elements are arranged on the processing units pertaining to the set of processing units. The external influences on the processing units can consequently be identified if said influences may actually or possibly have negative impacts on the processing units.

According to an exemplary embodiment, the electronic elements pertaining to the set of electronic elements are arranged sequentially. As a result thereof, a well-ordered and clear identification of external influences can be carried out.

According to an exemplary embodiment, the data have a data pattern that is configured for the identification of external influences on at least one processing unit pertaining to the set of processing units. As a result thereof, in the identification of external influences, it may be possible to use known, tried and/or tested pattern recognition methods to check the correctness of the data transmitted by the sensor circuit. As a result thereof, an efficient procedure may be facilitated, in which effective pattern recognition methods tailored to the relevant situation can be used.

According to an exemplary embodiment, the data comprise a time stamp, wherein the time stamp indicates at what time the data were generated by the data generator for transmission to the sensor circuit. As a result thereof, a further factor can be used to check the correctness of the data transmitted by the sensor circuit.

According to an exemplary embodiment, the data comprise an error detection suffix, wherein the error detection suffix is configured in such a way that the checking of the correctness of the data is carried out by the data checker using the error detection suffix. As a result thereof, reliable detection of external influences is facilitated.

According to an exemplary embodiment, the data generator may be configured to generate the error detection suffix using the data pattern.

According to an exemplary embodiment, the data generator may be configured to generate the error detection suffix using the data pattern and the time stamp.

According to an exemplary embodiment, the arrangement may comprise a power supply to the sensor circuit in order to supply the sensor circuit with power.

Furthermore, according to an exemplary embodiment, the sensitivity of the sensor circuit to the external influences is regulated by selecting a level for a voltage that is provided by the power supply to the sensor circuit. As a result thereof, there may be the option of adjusting the sensor circuit to match individual requirements and/or current circumstances.

According to an exemplary embodiment, the arrangement comprises a transmitter that is configured to receive the data from the data generator and transmit said data in cycles to the sensor circuit.

According to an exemplary embodiment, the data generator may be configured to generate the data in cycles. As a result thereof, continuous checking of an embedded system is facilitated.

According to an exemplary embodiment, the arrangement may comprise a receiver that is configured to receive the data from the sensor circuit and make said data available to the data checker.

According to an exemplary embodiment, the arrangement may comprise an observation circuit that is configured to check for accuracy signals that are transmitted from a first processing unit pertaining to the set of processing units to a second processing unit pertaining to the set of processing units. As a result thereof, some embodiments may provide an additional mechanism for the identification of external influences.

According to an exemplary embodiment, the observation circuit may be configured to check input signals, intermediate signals and/or output signals pertaining to the first processing unit, input signals, intermediate signals and/or output signals being such signals from which originate the signals that are transmitted from the first processing unit to the second processing unit. In this way, a flexible and precise check of the functionality of the processing units may be facilitated.

According to an exemplary embodiment, the data checker may be configured to compare the data generated by the data generator with the data that the data checker has received from the sensor circuit, wherein the data generated by the data generator correspond to the data that the data checker has received from the sensor circuit.

According to an exemplary embodiment, the set of processing units may comprise at least one of the following as a processing unit: a channel and/or a main processor.

Certain embodiments provide an embedded system that comprises an arrangement for the identification of external influences on at least one processing unit pertaining to a set of processing units in the embedded system, wherein the arrangement corresponds to the arrangement that was introduced in the aforementioned and is subsequently explained in more detail.

Some embodiments provide a method for the identification of external influences on at least one processing unit pertaining to a set of processing units in an embedded system, wherein the method comprises:
generation of data that are configured for the identification of external influences on at least one processing unit pertaining to the set of processing units;
transmission of the data to a data checker by a sensor circuit that comprises a set of electronic elements that are configured for the storage of data, wherein the sensor circuit transmits the data to the data checker by means of sequential intermediate storage of the data in the electronic elements;
checking of the correctness of the data by the data checker.

Here, checking the correctness of the data should be understood as checking that the data generated match the data transmitted by the sensor circuit. That is, a check is carried out to determine whether the data have been changed or distorted during transmission by the sensor circuit. If the data have been changed or distorted, they are considered to be incorrect. In this case there is an external or outside influence present. According to the some embodiments, the method determines the external or outside influence by detecting the inaccuracy or distortion of the data. If the data generated match the data transmitted by the sensor circuit, then the data are correct and there is no external or outside influence present.

According to an exemplary embodiment, the method may be carried out by the arrangement introduced in the aforementioned and subsequently explained in more detail or components thereof respectively. Consequently the method may be configured to carry out the actions of the arrangement or of components thereof respectively.

Furthermore, some embodiments provide a data unit that:
is configured for the identification of external influences on at least one processing unit pertaining to a set of processing units in an embedded system;
is provided or configured for transmission by a sensor circuit to a data checker for the identification of external influences, wherein the sensor circuit comprises a set of electronic elements that are configured for the storage of data, and wherein the sensor circuit transmits the data unit to the data checker by means of sequential intermediate storage of the data unit in the electronic elements of the sensor circuit; and
is configured for checking the correctness thereof by the data checker.

The data unit may correspond to the data which are generated in the context of the arrangement introduced in the aforementioned and subsequently explained in more detail, which are transported by a sensor circuit and which are subsequently checked for correctness.

According to an exemplary embodiment, the data unit may comprise a data pattern that is configured for the identification of external influences on at least one processing unit pertaining to the set of processing units.

According to an exemplary embodiment, the data unit may comprise an error detection suffix; and the error detection suffix is configured such that the checking of the correctness of the data unit is carried out by the data checker using the error detection suffix.

According to an exemplary embodiment, the error detection suffix may be generated using the data pattern.

According to an exemplary embodiment, the data unit may comprise a time stamp that indicates at what time the data unit was generated.

According to an exemplary embodiment, the error detection suffix may be generated using the data pattern and the time stamp.

Certain embodiments may provide a reliable, secure, flexible, effective, and/or efficient identification of external influences in an embedded system. As a result thereof, the reliability of the embedded systems and of the processing units or components thereof may be increased considerably.

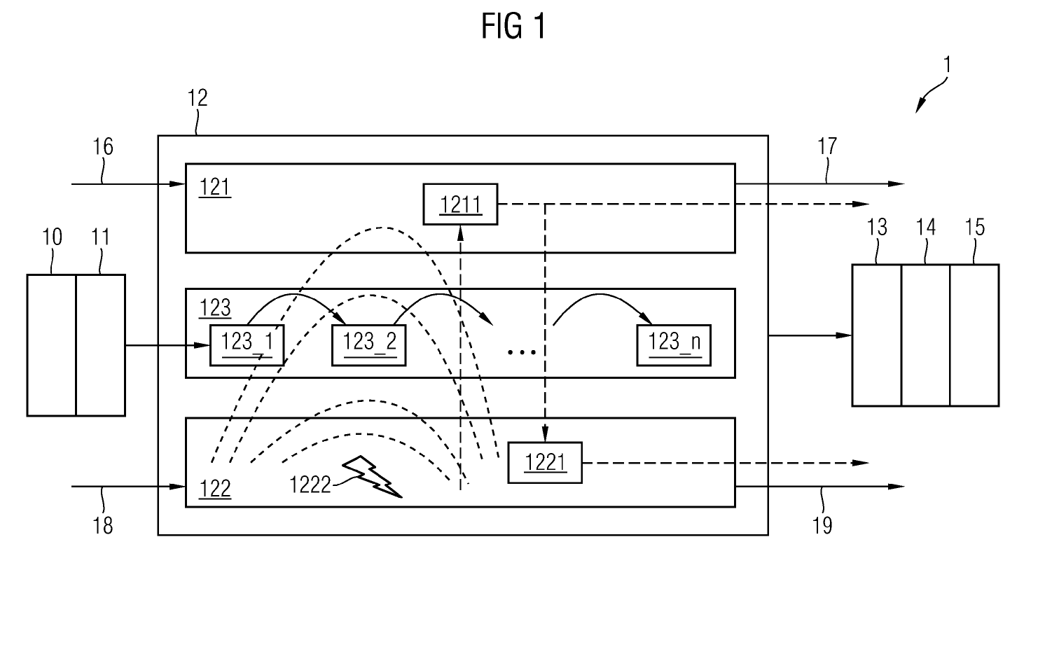

FIG. 1 illustrates an arrangement 1 for the identification of external influences on at least one processing unit 121, 122 pertaining to a set of processing units 121, 122 in an embedded system according to an exemplary embodiment of the present disclosure.

According to this exemplary embodiment, a two-channel circuit is provided, for example, in an embedded system for the transmission of data via channels 121 and 122 that constitute processing units 121, 122 of the embedded system. Input data 16 enter a first channel 121 and are processed and/or transmitted by the first channel 121. Completed transmission of the data or the results of the processing of the data 16 is indicated in FIG. 1 by the output data 17 for the first channel 121. Input data 18 enter the second channel 122 and are processed and/or transmitted by said second channel 122. Completed transmission of the data or the results of the processing of said data 18 is indicated in FIG. 1 by the output data 19 from the second channel 122. According to the present exemplary embodiment, the two channels 121, 122 are placed on a chip 12.

It should be noted here that embodiments of the present disclosure are not restricted to such architectures of embedded systems that comprise only two channels that constitute processing units on a chip. Certain embodiments are applicable to any other architectures having a corresponding design that uses channels that are intended where possible to be independent of each other. Such architectures could be, for example, dual channel cross checking; two-channel architectures with an external comparator, or 2-out-of-3 architectures. The processing units, such as channels, for example, may also be placed on more than one chip.

Furthermore, the embedded system may comprise at least one processing unit such as, for example, a channel.

If, for example, an error 1222 occurs in the second channel 122 or if circumstances arise that lead to an error 1222 in the channel 122 (for example, increased temperature and so forth), this error 1222 may also impact on the first channel 121. The extent of such impacts is shown by way of example in FIG. 1 by the dotted curves. Here the impacts caused by the error 1222 also extend from the point or zone where the error 1222 was located into the direction of the first channel 121. According to the present exemplary embodiment, the first channel 121 is located in a zone of the embedded system, that is or could be affected by the impacts of the error 1222. That is, as a result of the error 1222, errors may be generated in the first channel 121. In the worst scenario, the error 1222 may cause a failure of the first channel 121.

In order to identify the influence of the error 1222 on the first channel 121, as is shown by way of example in FIG. 1, in good time (that is, before the occurrence of errors in the first channel 121 and before the failure of the first channel 121) and to consequently guarantee a reliable functioning of the embedded system, a sensor circuit 123 is used according to the present exemplary embodiment. The sensor circuit 123 comprises a set of electronic elements 123_1, 123_2, . . . , 123_{—}n that are configured for the storage or intermediate storage of data. In particular the electronic elements 123_1, 123_2, . . . , 123_{—}n are configured such as to carry out transmission of data by means of a sequential storage or intermediate storage of data. That is, the data to be transmitted are further transmitted in a predetermined sequence starting from a first electronic element 123_1, 123_2, . . . , 123_{—}n configured for transmission up to a final electronic element 123_1, 123_2, . . . , 123_{—}n configured for transmission, wherein the electronic element 123_1, 123_2, . . . , 123_{—}n that currently comprises the data to be transmitted intermediately stores said data for a predetermined time before it further transmits the data to a further electronic element 123_1, 123_2, . . . , 123_{—}n.

According to an exemplary embodiment, the data are further transmitted and intermediately stored, from the electronic element 123_1, via the electronic element 123_2 up to the electronic element 123_{—}n. That is, firstly the first electronic element 123_1 in the transmission sequence 123_1, 123_2, . . . , 123_{—}n receives the data to be transmitted and intermediately stores these data, then the first electronic element 123_1 transmits the data to a further electronic element 123_2 that intermediately stores the data and then transmits these data after a predetermined time to the next electronic element in the transmission sequence 123_1, 123_2, . . . , 123_{—}n. This procedure continues until the final electronic element 123_{—}n in the transmission sequence 123_1, 123_2, . . . , 123_{—}n has been reached. The final electronic element 123_{—}n receives the data to be transported, intermediately stores these data and then transmits the data by means of a receiver 13 to a data checker 14 that checks the correctness of the data transmitted or reached by the transmission sequence 123_1, 123_2, . . . , 123_{—}n after carrying out the many steps of intermediate storage in the sensor circuit 123.

It should be noted that the electronic elements in the transmission sequence 123_1, 123_2, . . . , 123_{—}n indeed have a predetermined sequence as far as the transmission and intermediate storage of data are concerned, but the electronic elements in the transmission sequence 123_1, 123_2, . . . , 123_{—}n do not definitely have to be physically arranged in sequence such that the sequence for the transmission and intermediate storage of the sequence corresponds to the physical arrangement thereof. Embodiments of present disclosure may allow various corresponding arrangements of the electronic elements in a transmission sequence 123_1, 123_2, . . . , 123_{—}n and various sorting arrangements of the electronic elements with respect to the sequence thereof.

According to an exemplary embodiment, the sensor circuit 123 is placed between the two channels 121, 122. It is consequently better able to identify influences originating from one channel 121, 122 that impact on the other channel 121, 122. The sensitivity of the sensor circuit 123 may be achieved, for example, by placing the electronic elements 123_1, 123_2, . . . , 123_{—}n in sufficiently close proximity to one another. That is, the closer together that the electronic elements 123_1, 123_2, . . . , 123_{—}n are placed, the better is the sensor circuit 123 able to identify or detect a negative external influence on one of the channels 121, 122. If such a negative external influence occurs, it then impacts on the transmission and intermediate storage of the data in the sensor circuit 123, meaning that the data concerned are changed during transmission and intermediate storage in the sensor circuit 123.

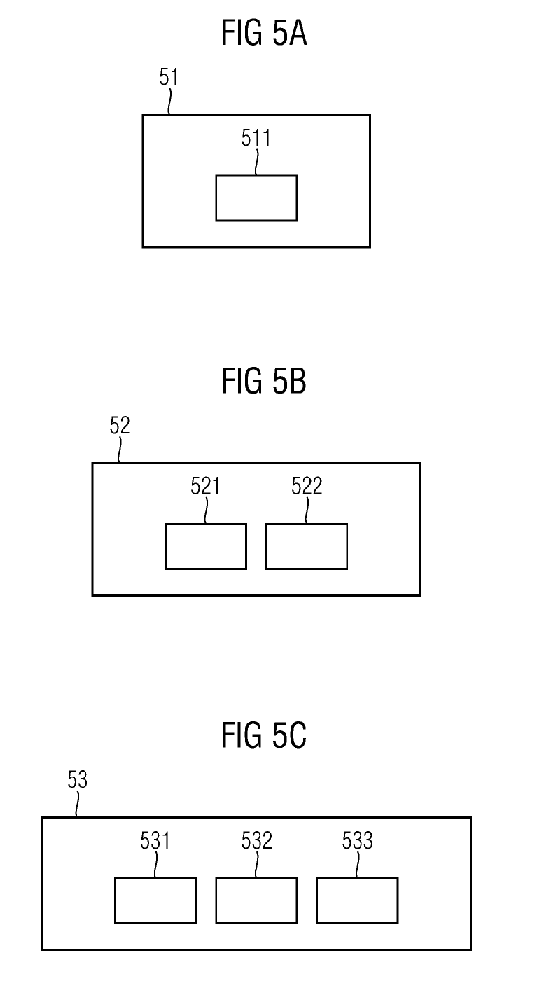

According to an exemplary embodiment, the data are generated or created by a data generator 10. The data generator 10 can create the data in cycles. This can be done at any, at random, or at predetermined time intervals. The data generator 10 generates the data such that they are configured for the identification of external influences. Possible embodiments of the data that are supported by the data generator 10 are explained below by way of example with reference to FIGS. 5a to 5c.

According to an exemplary embodiment the data generator 10 transmits the data that have been generated, which are configured for the identification of external influences, to a transmitter 11. The transmitter 11 then transmits the data to the sensor circuit 123 for the transmission and intermediate storage of the data in the sensor circuit 123. The transmitter 11 can transmit the data to the first electronic element 123_1 in the sensor circuit 123, for example. Furthermore, the transmitter 11 can be configured such that it sends or transmits the data to the sensor circuit 123 in cycles. This can be done at any, at random, or at predetermined time intervals. Furthermore, the transmission of the data by the transmitter 11 can be synchronized with the data generator 10.

If the data are generated by the data generator 10 in cycles and sent by the transmitter 11 to the sensor circuit 123 in cycles, the sensor circuit 123 is then configured to transmit or transfer data in cycles. In this event, the data are intermediately stored in cycles, the intermediate storage and the transmission being carried out by the sensor circuit 123 for each data unit that has been generated in cycles or consecutively as explained in the aforementioned.

In particular, the data that have been generated in cycles or consecutively, running consecutively from the electronic element 123_1 via the subsequent electronic elements 123_2, . . . , 123_{—}n−1 up to the final electronic element 123_{—}n in the transmission sequence 123_1, 123_2, . . . , 123_{—}n are further transmitted and intermediately stored. As soon as a consecutively or cyclically generated data unit from one electronic element 123_{—}k has been stored in the next electronic element 123_{—}k+1 (where 1≦k<n), the next consecutively or cyclically generated data unit is stored in the electronic element 123_{—}k. As described in the aforementioned, this procedure is carried out for a consecutively or cyclically generated data unit until the final electronic element 123_{—}n in the transmission sequence 123_1, 123_2, . . . , 123_{—}n has been reached. According to an exemplary embodiment, such a further transmission of consecutively or cyclically generated data can also be carried out simultaneously. That is, whilst one data unit is transmitted for example from the electronic element 123_{—}k to the electronic element 123_{—}k+1, a different data unit is transmitted from the electronic element 123_{—}j to the electronic element 123_{—}j+1 (where 1≦j<n and j≠k). In this way, according to some embodiments, consecutively or cyclically generated data or data units can be transmitted or transferred and intermediately stored by the sensor circuit 123.

It should be noted here that certain embodiments may also allow further possibilities for the transmission to the sensor circuit 123 of the data for the identification of external influences that have been generated by the data generator 11. Further suitable mechanisms can also be used for this purpose. Furthermore, the data generator 10 itself can also send or transmit the data that have been generated by said data generator to the sensor circuit 123.

According to an exemplary embodiment, the arrangement 1 comprises a receiver 13 that is configured to receive the data transmitted and intermediately stored by the sensor circuit 123. The receiver 13 can receive the data direct from the final electronic element 123_{—}n for example, various corresponding configurations being conceivable here.

Furthermore, the arrangement 1 according to the present exemplary embodiment also comprises a data checker 14. The data checker 14 receives the data that have been transmitted and intermediately stored by the sensor circuit 123 and checks these data for correctness. That is, the data checker 14 is configured so as to check whether the data have changed during transmission and intermediate storage in the sensor circuit 123.

According to an exemplary embodiment, the receiver 13 transmits the data to the data checker 14. However, the some embodiments allow yet more options for the transmission of the data to the data checker. Thus, for example, the data checker 14 itself is able to receive the data from the sensor circuit 123.

Furthermore, the arrangement 1 comprises a response detection element 15 that is configured so as to check that the system status is reliable. If, for example, the data checker 14 has found that the data transmitted and intermediately stored by the sensor circuit 123 are not correct, that is, that they have changed during transmission and intermediate storage, this is a sign that there is a malfunction or an error in the embedded system. That is, the operation of at least one processing unit 121, 122 is faulty, impaired or impossible due to external influences. In such a case the data checker 14 notifies the response detection element 15 that there is an unreliable system status. The data checker 14 can also be configured to provide further information relevant to the reliability of the system. The response detection element 15 is then configured to create a reliable system status using the data or information provided by the data checker 14. This may take the form, for example, of a contact in a bias current loop. Furthermore, the response detection element 15 can, for example, actuate or carry out a shut-off of the embedded system or of the respective processing units of the embedded system, and actuate or carry out an error display and so forth in response to the detection of the inaccuracy of the data. Some embodiments may allow various responses or actions of the response detection element 15 directed at a given situation in order to handle the respective external impacts and/or the effects thereof.

According to an exemplary embodiment, the arrangement further comprises at least one observation circuit 1211, 1221 that is configured to check signals that are transmitted from one processing unit 121, 122 of the embedded system to a further processing unit 121, 122 of the embedded system. If the signals contain errors, there is then an external influence and/or a malfunction of the respective processing unit impairing the smooth functioning of further processing units.

This observation circuit 1211, 1221 can be located in the vicinity of processing units 121, 122 of the embedded system and/or in the processing units 121, 122 of the embedded system.

According to an exemplary embodiment, each processing unit of the embedded system, that is, each channel 121, 122, comprises an observation circuit 1211, 1221.

Each of the observation circuits 1211, 1221 is aware of the processing and transmission procedures in the respective channel 121, 122 in which it is located, and is configured to check such signals that are transmitted as output signals 17, 18 to the respective other channel as input signals. Such signals under test may be output signals 16, 18, intermediate signals (that are still being processed or transmitted in the channel) and/or output signals 17, 19.

According to an exemplary embodiment, the observation circuit 1211 in the first channel 121 transmits such a signal under test pertaining to the first channel 121 to the observation circuit 1221 in the second channel 122. The observation circuit 1221 in the second channel 122 then checks whether the signal under test from the first channel 121 is correct. Conversely, the observation circuit 1221 in the second channel 122 transmits a signal under test pertaining to the second channel 122 to the observation circuit 1211 in the first channel 121. The observation circuit 1211 in the first channel 121 then checks whether the signal under test pertaining to the second channel 122 is correct.

If there is an error or a malfunction 1222 in the second channel 122, as shown in FIG. 1, a corresponding intermediate signal or output signal 19 in the second channel 122 will contain an error. According to the present exemplary embodiment, the observation circuit 1221 in the second channel 122 transmits the respective signal under test to the observation circuit 1211 in the first channel 121. Since there is an error or a malfunction 1222 in the second channel 122, the checking of the signal by the observation circuit 1211 in the first channel 121 will show that the respective signal contains an error or is inaccurate. In such a case an observation circuit 1211, 1221 is configured to send a corresponding notification (via a signal, for example) outside or to the response detection element 15 in order to effect or actuate the restoration of a reliable status in the embedded system.

Such signals that lead from one channel 121, 122 to the other and that are to be observed and tested by the observation circuit 1211, 1221 can be used, for example, to implement a cross-check architecture. To this end, the input signals 16, 18, the output signals 17, 19 and optionally the intermediate results are tested in order to reveal, detect or identify in this way errors in the respective other channel.

According to an exemplary embodiment, some elements of the arrangement 1 are located outside the chip 12. In FIG. 1, such elements are the data generator 10, the transmitter 11, the receiver 13, the data checker 14 and the response detection element 15. It should be noted, however, that this is only a feature of the configuration according to the present exemplary embodiment and that, according to certain embodiments, further different locations of said elements are possible. Embodiments of present disclosure are not limited to the placing of the elements of the arrangement 1 as shown in FIG. 1.

If, for example, an error 1222 occurs in the second channel 122, which error could potentially also adversely affect the first channel 121 in a similar manner or vice versa, or if, for example, an external influence adversely affects both channels 121, 122 and leads to malfunctions in both channels 121, 122, the data checker 14 will recognize this as a result of the presence of changes in the data which have been created accordingly by the data generator and were transported by the sensor circuit 123. The probability that, as a result of an external or outside influence, the respective impacts have also occurred with respect to the sensor circuit 123 and that the data transmitted by the sensor circuit 124 have also been changed is very high in such a case. The data checker 14 will then signal to the response detection element 15 that a critical error has occurred. In response thereto, the response detection element 15 will then in any event restore a reliable system status.

In some embodiments, there may be a very high probability that external influences, that is, Common Cause Failures (due, for example to a simultaneous rise in temperature, mechanical problems, EMC problems and so on) will be recognized or identified.

The arrangement 1 may be used, for example, for the disclosure, identification or detection of such failures and/or errors which create “crosstalk” or are passed on from one channel 121, 122 to the other, failures and/or errors which include temperature increases that as a Common Cause Failure would lead to a malfunction of both channels 121, 122 and failures and/or errors such as EMC problems, for example, which as a Common Cause Failure would lead to a malfunction of both channels 121, 122 and would therefore not definitely be detected by a simple comparison of the aforementioned safety-related control devices and so on.

Furthermore, the data generator 10, the transmitter 11, the sensor circuit 12, the receiver 13 and the data checker 14 may be provided with their own clock. In this way, a customized and effective identification of external influences can be achieved.

In addition, the data generator 10, the transmitter 11, the sensor circuit 12, the receiver 13 and the data checker 14 can be provided with their own power supply such that an improved response to errors can be achieved when supplying the chips.

Furthermore, the sensitivity of the sensor circuit 12 can be influenced by the selection of appropriate voltage levels. At lower voltage levels the sensor circuit 12 will be more susceptible and therefore more sensitive to external influences. As a result thereof, there is an increased probability that the data transmitted by the sensor circuit 12 will change.

Furthermore, some embodiments may also be implemented with reference to further processing units or components of an embedded system and not only with reference to channels. For instance, CPLDs (“Complex Programmable Logic Devices”), FPGAs (“Field Programmable Gate Arrays”) and so forth may be mentioned as possible applications of certain embodiments.

In addition, it should be noted that the components of arrangement 1 (the data generator 10, the transmitter 11, the receiver 13 and the data checker 14, for example) may be software and/or hardware components. Various configurations of the respective components and/or modules are possible according to some embodiments.

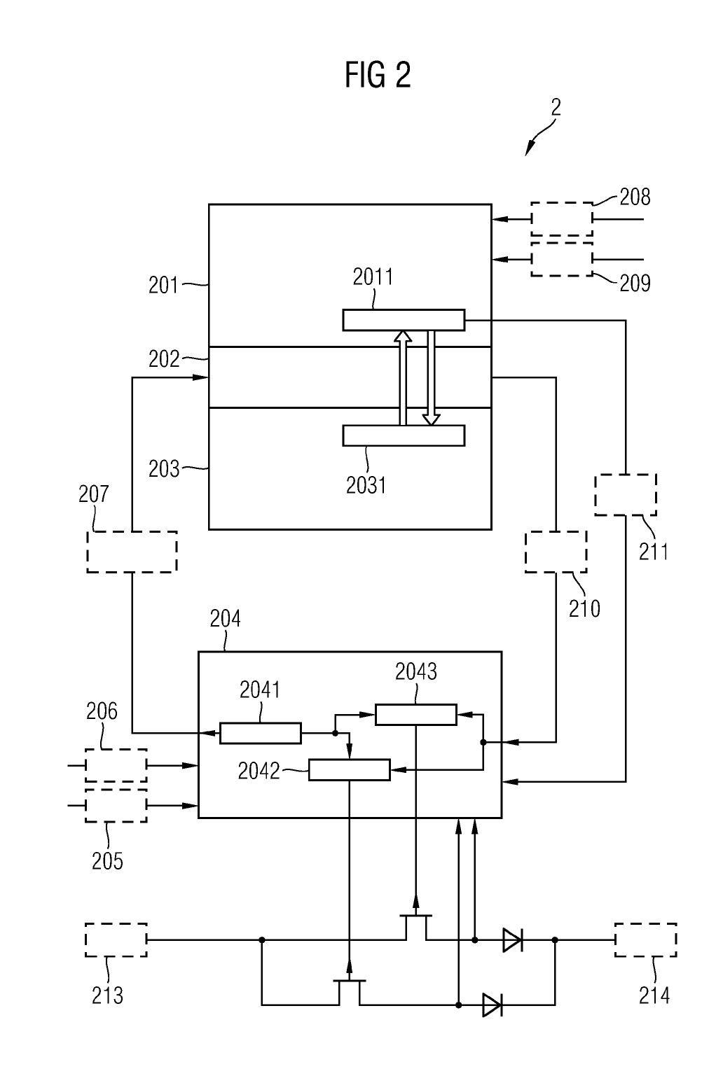

FIG. 2 shows a further arrangement 2 for the identification of external influences on at least one processing unit 201, 203 pertaining to a set of processing units in an embedded system according to an exemplary embodiment. This exemplary embodiment may be implemented with reference to a multi-core processor, wherein the processing units or components 201, 203 represent two main processors of a multi-core processor and according to the present exemplary embodiment are handled in a similar manner to the channels 121, 123 in FIG. 1 with respect to external or outside influences. According to this exemplary embodiment, the main processors 201, 203 communicate with each other via observation circuits 2011, 2031. According to this exemplary embodiment, the observation circuits 2011, 2031 generally correspond to the observation circuits 1211, 1221 in FIG. 1. Furthermore, the arrangement 2 according to this exemplary embodiment may comprise a diagnostic circuit 204 that is configured to recognize or to identify external or outside influences on the main processors 201, 203.

According to an exemplary embodiment, the main processors 201, 203 have a power supply “Vcc1, Vcc2” 208 and a clock generator “CLK” 209. According to the present exemplary embodiment, the power supply “Vcc1, Vcc2” 208 and clock generation “CLK” 209, are configured to be independent of the diagnostic circuit 204. According to the present exemplary embodiment, the diagnostic circuit 204 again comprises a power supply “VCC3” 206 and a clock generator “CLK2” 205, said power supply “VCC3” 206 and the clock generator “CLK2” 205 being configured independently of the main processors 201, 203.

According to an exemplary embodiment, the diagnostic circuit 204 is configured or designed to carry out the functions of the following units or modules described in FIG. 1: the data generator 10, the transmitter 11, the receiver 13 and the data checker 14.

According to an exemplary embodiment, the diagnostic circuit 204 sends sensor data 207 to a sensor circuit 202, which is configured or designed in a similar manner to the sensor circuit 123 in FIG. 1. The sensor data 207 are the data 2041 generated by the diagnostic circuit 204 and correspond to the data generated by the data generator 10 in FIG. 1. These sensor data 207 may be a sensor data stream, for example. The sensor data 207 are received by the sensor circuit 202 and are transported by the sensor circuit 202 as explained with reference to the exemplary embodiment shown in FIG. 1 and are intermediately stored in the respective electronic elements in the sensor circuit 202. After the transmission of the sensor data 207 by the sensor circuit 202, transmitted sensor data 210 are received. The transmitted sensor data 210 are transmitted by the sensor circuit 202 to the diagnostic circuit 204.

According to an exemplary embodiment, the diagnostic circuit 204 comprises two data-checking modules or elements 2042, 2043 that are configured to check the correctness of the transmitted sensor data 210 as described above with reference to FIG. 1. Here the data-checking modules or elements 2042, 2043 are configured to undertake or carry out the checking of the correctness of the transmitted sensor data 210 using the data 2041 generated by the diagnostic circuit 204, which data have been sent as sensor data 207 to the sensor circuit 202. If the data-checking modules or elements 2042, 2043 detect a deviation from the originally generated data 2041, the data-checking modules or elements 2042, 2043 then actuate a transistor circuit such that an error is displayed on the element 214. Thereupon, at least one appropriate response to the handling of the external influence that has occurred and/or of the effects thereof is determined and carried out. Here, element 213 may be a power supply.

According to an exemplary embodiment, the observation circuits 2011, 2031 are configured to exchange between them and then to check for accuracy the signals, data and/or information that have been input, intermediately processed or finally processed in the respective main processors 201, 203 (as already explained in FIG. 1 with reference to the observation circuits 1211, 1221). If errors are detected with respect to the signals, data and/or information that have been exchanged, the observation circuits 2011, 2031 are then configured according to the present exemplary embodiment to transmit error signals, error data and/or error information 211, 212 to the diagnostic circuit 204. The diagnostic circuit 204 then initiates the determination and/or carrying out of at least one suitable response to handle the external influence that has occurred and/or the effects thereof that have been detected using the error signals, error data and/or error information 211, 212.

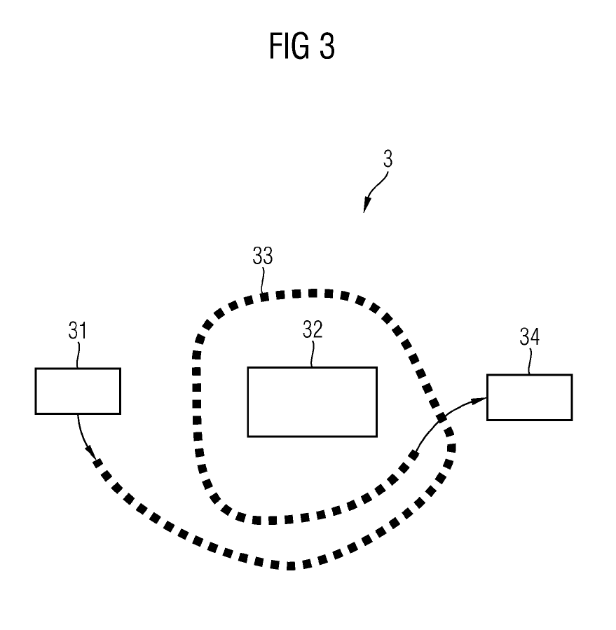

FIG. 3 shows an arrangement 3 for the identification of external influences on at least one processing unit 32 pertaining to a set of processing units in an embedded system according to an exemplary embodiment. According to this exemplary embodiment, the embedded system comprises a processing unit 32. FIG. 3 shows by way of example a possible arrangement of a sensor circuit 33 around a processing unit 32 as described in the aforementioned in more detail with reference to FIG. 1 and FIG. 2. Here the electronic elements of the sensor circuit 33 are placed around the processing unit 32 such that external influences from various directions can be identified or detected. A data generator 31 is configured to generate data as explained with reference to the data generator 10 in FIG. 1. These data are transmitted by the sensor circuit 33 and intermediately stored. A data checker 34 is configured to check the correctness or accuracy of the data transmitted by the sensor circuit 33 in order to determine whether there are external or outside influences present that could interfere with or impair the functionality of the processing unit 32.

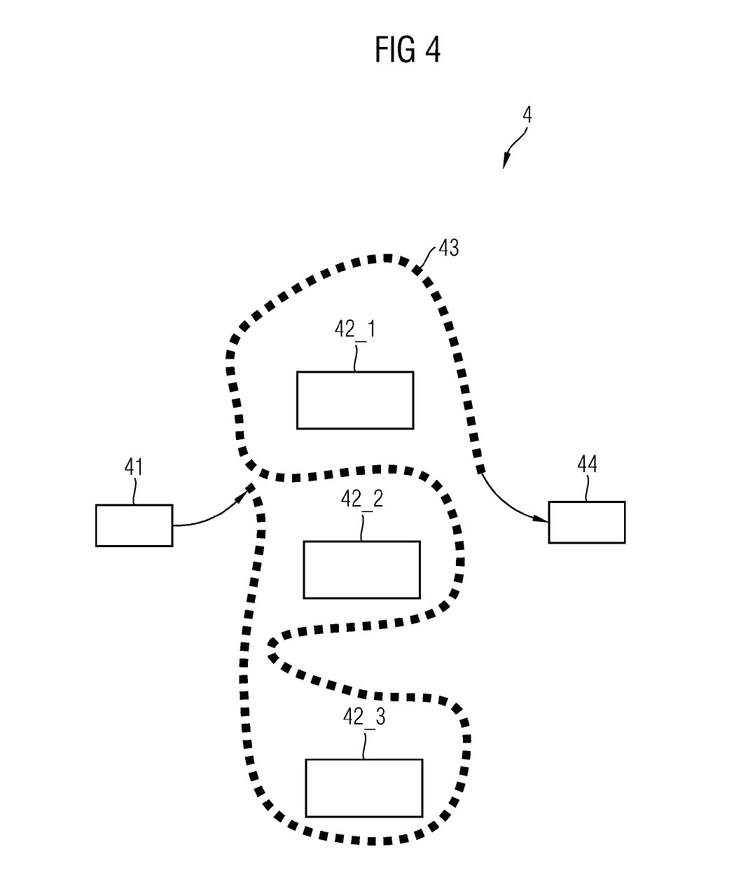

FIG. 4 shows a further arrangement 4 for the identification of external influences on at least one processing unit 42_1, 42_2, 42_3 in a set of processing units 42_1, 42_2, 42_3 in an embedded system according to an exemplary embodiment. This exemplary embodiment may be used with reference to a plurality of processing units 42_1, 42_2, 42_3 pertaining to an embedded system. According to this exemplary embodiment, the functionality of at least three processing units 42_1, 42_2, 42_3 is checked. Here a sensor circuit 43 is placed around the processing units 42_1, 42_2, 42_3 such that external or outside influences from various directions around the processing units 42_1, 42_2, 42_3 can be identified or detected.

A data generator 41 in the arrangement 4 is configured to generate data, as explained with reference to the data generator 10 in FIG. 1. These data are transmitted by the sensor circuit 43 and intermediately stored. A data checker 44 is configured to check the correctness or accuracy of the data transmitted by the sensor circuit 43 in order to ascertain whether there are external or outside influences present that could interfere with or impair the functionality of the processing units 42_1, 42_2, 42_3.

In this way, by means of a suitable arrangement of a sensor circuit 123, 202, 33, 43, any number of processing units or components 121, 122, 201, 203, 32, 42_1, 42_2, 42_3 of an embedded system can be monitored for external influences such that a response can be made thereto.

Consequently, certain embodiments can be used, implemented and/or carried out in a flexible and effective manner with respect to any number of processing units or components 121, 122, 201, 203, 32, 42_1, 42_2, 42_3 of an embedded system.

Various embodiments of data that can be used according to certain embodiments for the identification of external influences will be described hereafter by way of example with reference to FIGS. 5a to 5c.

FIG. 5a shows a data unit 51 that is configured according to an exemplary embodiment of the present disclosure for the identification of external influences on at least one processing unit in a set of processing units in an embedded system. The data unit 51 is generated by a data generator that corresponds to one of the data generators described in the aforementioned in such a way that it has a specific data pattern 511. The data pattern 511 is configured in such a way that it is suitable for the identification of external influences during a transmission by a sensor circuit that corresponds to one of the sensor circuits described in the aforementioned. That is, the data pattern 511 is as sensitive as possible to errors and allows as many distortions as possible of the data pattern 511 to be identified. It is important in the identification of external influences that, when external influences do exist, the data transmitted by the sensor circuit have actually been changed by the external influences. The greater the sensitivity to error of the data pattern 511, the more probable it is that when external influences do exist, the data unit 51 or the data pattern 511 transmitted by the sensor circuit will have been changed. The data checker is then configured to carry out a data pattern check, which checks whether the pattern received by the data checker corresponds to the expected pattern 511.

FIG. 5b shows a data unit 52 that is configured, according to an exemplary embodiment, to identify external influences on at least one processing unit pertaining to a set of processing units in an embedded system. As in FIG. 5a, the data unit 52 comprises a data pattern 521. The data pattern 521 generally corresponds to the data pattern 511 shown in FIG. 5a. Furthermore, according to this embodiment, the data unit 52 comprises an error detection suffix 522. According to this embodiment, the error detection suffix 522 is configured or designed such that checking of the correctness of the data unit 52 or of the data pattern 521 respectively can be carried out by means of the error detection suffix 522.

According to an exemplary embodiment, the error detection suffix 522 is generated by a data generator with respect to the data pattern 521. Thus, for example, the error detection suffix 522 can be generated using the “cyclic redundancy check” (CRC) method. CRC is a method for determining a test value for data in order to be able to recognize errors in the transmission or storage. For each data unit 52 that is transmitted by the sensor circuit or for the data pattern 521 of the data unit 52 respectively, a “CRC value” is calculated using a specific method. This CRC value is incorporated into the data unit 52 as the error detection suffix 522. When checking the data unit 52 or the data pattern 521 respectively, the data checker uses the same method of calculation as the data generator does for the data pattern 521 including the attached CRC value or the error detection suffix 522. If the result equals zero it can be assumed that the data unit 52 or the data pattern 521 respectively is correct.

CRC may be configured such that there is a high probability that errors in the transmission of the data or in the transmission of the data units 52 by the sensor circuit, which could be caused by noise in the transmission channel, for example, will be detected. That is, in some embodiments, there may be a very high probability that external influences on at least one processing unit or component of an embedded system will be detected.

According to an exemplary embodiment, it is possible to calculate the Hamming distance in order to determine an appropriate data pattern 521. The Hamming distance is a yardstick used to determine the variability of strings or data patterns 521, the Hamming distance for two data patterns with a fixed length being the number of different points in the data patterns that have to be distorted in order to again generate a valid code word that is not recognizably distorted. The Hamming distance is generally known and will therefore not be discussed in further detail hereafter. According to this exemplary embodiment, the data patterns 521 are selected such that the Hamming distance for the in principle freely selectable error detection suffix 522 is as great as possible, because the greater the Hamming distance, the higher the error detection rate will be. That is, the desired sensitivity of the data pattern 521 increases with increasing Hamming distances.

FIG. 5c shows a further data unit 53, which is configured according to an exemplary embodiment for the identification of external influences on at least one processing unit pertaining to a set of processing units in an embedded system. The data unit 53 also comprises a time stamp 533, in addition to a data pattern 531 and in addition to an error detection suffix 532. The time stamp 533 indicates at what time or at what point in time the data unit 53 was generated. The time stamp 533 can likewise be used to check the correctness of the data unit 53 after transmission by the sensor circuit. The data pattern 531 generally corresponds to the data patterns 511, 521 in FIGS. 5a and b, described in the aforementioned. The error detection suffix 532 again generally corresponds to the error detection suffix 522 from FIG. 5b, described in the aforementioned, optionally including the time stamp.

According to an exemplary embodiment, the error detection suffix 532 can be generated with respect to the data pattern 531 and with respect to the time stamp 533. The time stamp can be used in the data checkers 14, 2042, 2043, 34, 44 to determine whether there are patterns in the data checker 14, 2042, 2043, 34, 44 that are indeed valid yet have been intermediately stored incorrectly although the transmission chain has been interrupted by the sensor 123, 202, 33, 43.

Consequently, some embodiments relate to the identification of external influences on at least one processing unit pertaining to a set of processing units in an embedded system, wherein an arrangement configured for this purpose comprises: a data generator that is designed to generate data which are configured for the identification of external influences on at least one processing unit pertaining to the set of processing units; a sensor circuit comprising a set of electronic elements, wherein the electronic elements are configured for the storage of the data, wherein the sensor circuit is configured to transmit the data to a data checker by sequential intermediate storage of the data in the electronic elements; and the data checker that is configured to check the correctness of the data. Certain embodiments may facilitate improved identification of external influences on at least one processing unit of an embedded system. It may be applicable with respect to embedded systems.

Although this disclosure discusses exemplary embodiments according to the attached drawings, it will be evident that the invention is not restricted thereto, but can be modified within the scope of the present disclosure. It is obvious that yet further exemplary embodiments are possible that represent and are equivalent to the principles disclosed herein and that various modifications can consequently be implemented without deviating beyond the scope of the invention.

What is claimed is:

1. An arrangement for the identification of external influences on at least one processing unit pertaining to a set of processing units in an embedded system, wherein the arrangement comprising:
a data generator configured to generate data that are configured for the identification of external influences on at least one processing unit pertaining to the set of processing units;
a sensor circuit comprising a set of electronic elements configured to store the data, wherein the sensor circuit is configured to transmit the data to a data checker by means of a sequential intermediate storage of the data in the electronic elements; and
the data checker, which is configured to check the correctness of the data.

2. The arrangement of claim 1, wherein the electronic elements are arranged on the processing units pertaining to the set of processing units.

3. The arrangement of claim 1, wherein the electronic elements pertaining to the set of electronic elements are arranged sequentially.

4. The arrangement of claim 1, wherein the data comprise a data pattern that is configured for the identification of external influences on at least one processing unit pertaining to the set of processing units.

5. The arrangement of claim 1, wherein the data have a time stamp that indicates at what the time the data were generated by the data generator for transmission to the sensor circuit.

6. The arrangement of claim 1, wherein the data comprise an error detection suffix configured such that the checking of the correctness of the data is carried out by the data checker using the error detection suffix.

7. The arrangement of claim 4, wherein the data generator is configured to generate the error detection suffix using the data pattern.

8. The arrangement of claim 4, wherein the data generator is configured to generate the error detection suffix using the data pattern and the time stamp.

9. The arrangement of claim 1, wherein the arrangement comprises a power supply for the sensor circuit to supply the sensor circuit with power.

10. The arrangement of claim 9, wherein the sensitivity of the sensor circuit is regulated with respect to external influences by a selection of a level of a voltage that is provided by the power supply to the sensor circuit.

11. The arrangement of claim 1, wherein the arrangement comprises a transmitter configured to receive the data from the data generator and transmit said data in cycles to the sensor circuit.

12. The arrangement of claim 1, wherein the data generator is configured to generate the data in cycles.

13. The arrangement of claim 1, wherein the arrangement comprises a receiver configured to receive the data from the sensor circuit and supply said data to the data checker.

14. The arrangement of claim 1, wherein the arrangement comprises an observation circuit configured to check for accuracy signals that are transmitted by a first processing unit pertaining to the set of processing units to a second processing unit pertaining to the set of processing units.

15. The arrangement of claim 14, wherein the observation circuit is configured to check input signals, intermediate signals and/or output signals pertaining to the first processing unit, wherein input signals, intermediate signals, and/or output signals are such signals from which the signals transmitted by the first processing unit to the second processing unit originate.

16. The arrangement of claim 1, wherein the data checker is configured to compare the data generated by the data generator with the data that the data checker has received from the sensor circuit, wherein the data generated by the data generator correspond to the data that the data checker has received from the sensor circuit.

17. The arrangement of claim 1, wherein the set of processing units comprises at least one of the following as a processing unit: a channel and a main processor.

18. An embedded system, comprising an arrangement for the identification of external influences on at least one processing unit pertaining to a set of processing units in the embedded system, wherein the arrangement comprises:
a data generator configured to generate data that are configured for the identification of external influences on at least one processing unit pertaining to the set of processing units;
a sensor circuit comprising a set of electronic elements configured to store the data, wherein the sensor circuit is configured to transmit the data to a data checker by means of a sequential intermediate storage of the data in the electronic elements; and
the data checker, which is configured to check the correctness of the data.

19. A method for the identification of external influences on at least one processing unit pertaining to a set of processing units in an embedded system, the method comprising:
generating data that are configured for the identification of external influences on at least one processing unit pertaining to the set of processing units;
transmitting the data to a data checker by a sensor circuit that comprises a set of electronic elements configured to store the data, wherein the sensor circuit transmits the data to the data checker by a sequential intermediate storage of the data in the electronic elements; and
checking the correctness of the data by the data checker.

20. A data unit including executable code stored in non-transitory computer-readable media and executable to, which:
identify external influences on at least one processing unit pertaining to a set of processing units in an embedded system;
transmit by a sensor circuit to a data checker for the identification of external influences, wherein the sensor circuit comprises a set of electronic elements configured to store data, and wherein the sensor circuit transmits the data unit to the data checker by a sequential storage of the data unit in the electronic elements; and
check the correctness thereof by means of the data checker.

21. The data unit of claim 20, wherein the data unit comprises a data pattern configured for the identification of external influences on at least one processing unit pertaining to the set of processing units.

22. The data unit of claim 20, wherein:
the data unit comprises an error detection suffix; and
the error detection suffix is configured such that the checking of the correctness of the data unit is carried out by the data checker using the error detection suffix.

23. The data unit of claim 20, wherein the error detection suffix is generated using the data pattern.

24. The data unit of claim 20, wherein the data unit comprises a time stamp that indicates at what time the data unit was generated.

25. The data unit of claim 20, wherein the error detection suffix is generated using the data pattern and the time stamp.
